(19) United States
(12) Patent Application Publication
(10) Pub. No.: US 2005/0256980 A1
(43) Pub. Date: Nov. 17, 2005

(54) Method for controlling input/output units, and an input/output unit

(75) Inventor: Shingo Kazuma, Minato-ku (JP)

Correspondence Address: SHINJYU GLOBAL IP COUNSELORS, LLP, 1233 20TH STREET, NW, SUITE 700, WASHINGTON, DC, 20036-2680, US

(73) Assignee: Oki Electric Co., Ltd., Minato-ku (JP)

(21) Appl. No.: 11/013,317

(22) Filed: Dec. 17, 2004

(30) Foreign Application Priority Data
May 14, 2004 (JP) JP 2004-144317

(51) Int. Cl. G06F 13/14

(52) U.S. Cl. 710/36

(57) ABSTRACT

A method of controlling an input/output unit (general purpose input/output module) with a plurality of submodules (terminal parts) includes said following; arranging each of the submodules to store an address including a first address part and a second address part, and grouping the submodules according to the first address part; receiving an access address for designating the first address part; selecting a group of submodules storing the first address part that matches the access address; controlling data transmission/reception via the selected submodules according to the second address part stored in each of the selected submodules.

### BACKGROUND OF THE INVENTION

1. Field of the Invention

The present invention generally relates to input/output units. More specifically, the present invention relates to a method of controlling input/output units, and an input/output unit.

2. Background Information

Generally, input/output units such as a general purpose input/output module (GPIO) are designed to be mounted on large scale integrated circuits (LSIs) and the like. One GPIO has one or more ports for external connections. Each port is a group of one or more external connection terminals. This kind of GPIO works as an interface for transmitting/receiving data between a semiconductor device and external parts. In order to serve this purpose, normally, different ports are provided for different external parts or applications. Each of the external terminals of each of the ports is set up with parameters such as an input/output direction, a reception of interruption direction, an output value, and so forth depending on the related external part or application.

With respect to the LSIs etc. for use in portable devices, multi-functionalization and reduction of mounting area are mainly required. In realizing the multi-functionalization, it is necessary to increase the degree of integration of the LSI. However, for this sake, the number of the external connection terminals mounted on the LSI increases. On the other hand, in order to reduce the mounting area, it is necessary to reduce the number of the external connection terminals mounted on the LSI chip. Therefore, in designing LSIs etc. for use in portable devices, two such conflicting demands are to be found.

In a conventional GPIO, it is fixedly decided which external connection terminal belongs to which port at the phase of designing. Therefore, it is extremely difficult to change the port structure after the related LSI is built as a chip of a semiconductor device. Even so, it is possible to change the port structure by using an address of a setting register even after the LSI is built as the chip of the semiconductor device. However, since the address of the setting register is fixed, this method requires complicated processing by software. For this reason, a problem of decrementing performance in terms of data transmission arises.

As one technique to solve the above-described problem, for example, Japanese Patent Application Laid-Open No. 10-334032, which is hereby incorporated by reference, discloses a computer system where a plurality of PCI (peripheral components interconnect) devices are connected with a CPU (central processing unit). Each PCI device has number setting registers, a decoder, and a selector. The setting registers set a device number. The decoder decodes the device number to an address selection signal. The selector compares the address selection signal with an address/data bus signal and produces an internal IDSEL signal according to that comparison result. The address selection signal has the same number of bits of the address/data bus signal. With respect to the address selection signal, a bit corresponding to the device number of the number setting register is asserted as 1. The address selection signal, whose bit corresponding to the device number of the PCI device that the address/data bus is targeting is asserted as 1, is inputted to all the PCI devices. Each PCI device which received the address selection signal compares the address selection signal with the address/data bus signal. If the corresponding bits of the two signals are asserted as 1, then the PCI device asserts the internal IDSEL signal as 1. In this manner, the PCI device in which the corresponding bits of the two signals are asserted as 1 is selected.

As described above, the computer system of the reference, Japanese Patent Application Laid-Open No. 10-334032, selects a certain PCI device among a number of PCI devices connected to the CPU by having the number setting register of each PCI device memorize its own device number, and each PCI device compare the address selection signal corresponding to the device number of the target PCI device with the address/data-bus signal (signal from the CPU). With this technique and structure, it may be possible to change flexibly the device numbers by rewriting the device numbers stored in the number setting registers. However, the device number serves as information to select a certain PCI device among a number of other PCI devices. In other words, each device number is set as a unique number, and no same number is given among the PCI devices. Accordingly, such structure is not meant for selecting a group of one or more external connection terminals among other groups of external connection terminals. In conclusion, the structure disclosed in the reference cannot be applied in a structure to change a group which has one or more external connection terminals as a port structure.

In view of the above, it will be apparent to those skilled in the art from this disclosure that there exists a need for an improved method of controlling input/output units, and an input/output unit. This invention addresses this need in the art as well as other needs, which will become apparent to those skilled in the art from this disclosure.

### SUMMARY OF THE INVENTION

It is therefore an object of the present invention to resolve the above-described problem and to provide a method of controlling input/output units which realizes an easy change in a port structure of an input/output unit. It is also an object of the present invention to provide an input/output unit in which an easy change in its port structure is possible.

In accordance with one aspect of the present invention, a method of controlling input/output units, in particular, a method of controlling an input/output unit with a plurality of terminal parts each of which stores an address including a first address part and a second address part, is provided. The method of the present invention includes the steps of: grouping the terminal parts according to the first address part; receiving an access address to designate the first address part; selecting a group of terminal parts storing the first address part that matches the access address; and controlling data transmission/reception via the selected terminal parts according to the second address part stored in each of the selected terminal parts.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

The above and further objects and the novel features of the invention will be more fully apparent from the following detailed description when the same is read in connection with the accompanying drawings, which form a part of this original disclosure, in which:

FIG. 1 is a schematic view of an LSI which uses a GPIO according to a preferred embodiment of the present invention;

FIG. 2 is a schematic view of an address decoder of the GPIO of FIG. 1;

FIG. 3 is a schematic view of mapping decoders of the address decoder of FIG. 2;

FIG. 4 is a schematic view of a mask circuit of one of the mapping decoders of FIG. 3;

FIG. 5 is a schematic view of an OR circuit of the GPIO of FIG. 1;

FIG. 6 is a view of a figure illustrating an example of group division of external connection terminals of the LSI of FIG. 1 in ports according to the present invention; and

FIG. 7 is a view of a flow chart illustrating a process of port access according the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

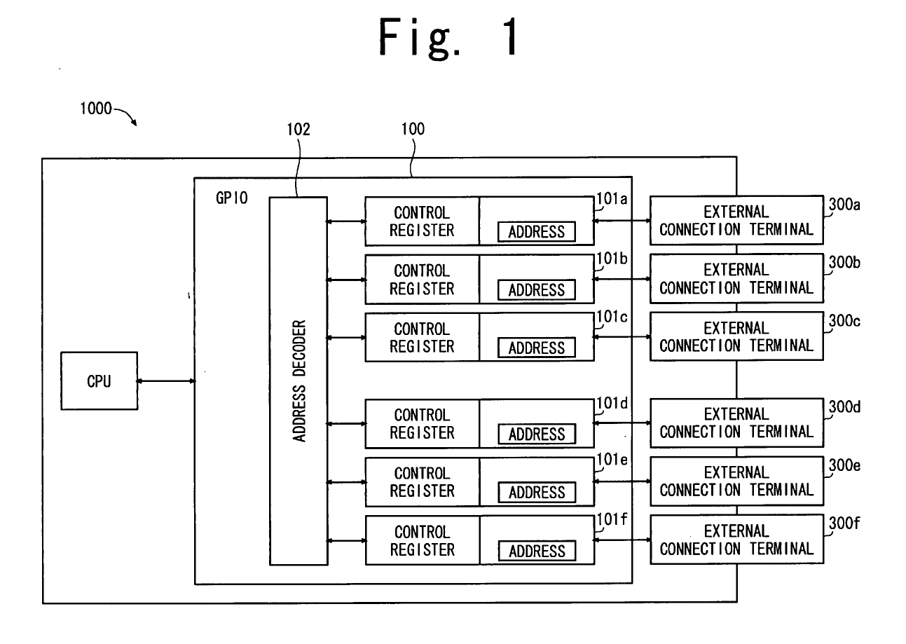

FIG. 1 is a schematic view of a large scale integrated circuit (LSI) 1000 which has a general purpose input/output module (GPIO) 100 according to the present invention. The LSI 1000 includes the GPIO 100, a CPU 200, and external connection terminals 300a to 300f.

The external connection terminals 300a to 300f are half-exposed outside the package of the LSI 1000 for the purpose of connecting internal circuits of the LSI 1000 to external circuits. Through the GPIO 100, the CPU 200 is capable of implementing data transmission/reception between the external circuits which are connected to the external connection terminals 300a to 300f.

As shown in FIG. 1, the GPIO 100 includes submodules 101a to 101f, and an address decoder 102. Each submodule composes a terminal part (bit) of the GPIO 100. The submodules 101a to 101f are electrically connected with the external connection terminals 300a to 300f in a one-to-one correspondence. For instance, the submodule 101a corresponds to the external connection terminal 300a, and is electrically connected to the external connection terminal 300a.

Each of the submodules 101a to 101f has a control register and an address register. The control register includes various types of registers for memorizing an input/output direction, a reception of interrupt direction, an output value, and so forth. The address register stores a port address representing a particular port, and a bit address representing a particular bit position of a data bus.

The address decoder 102 receives an access address representing the port of access from the CPU, and selects a certain submodule corresponding with the received access address among the submodules 101a to 101f. The selected submodule outputs the data received from the CPU 200 to the external circuits via the external connection terminals 300a to 300f. The selected submodule also inputs the data received from the external circuits via the external connection terminals 300a to 300f to the CPU 200.

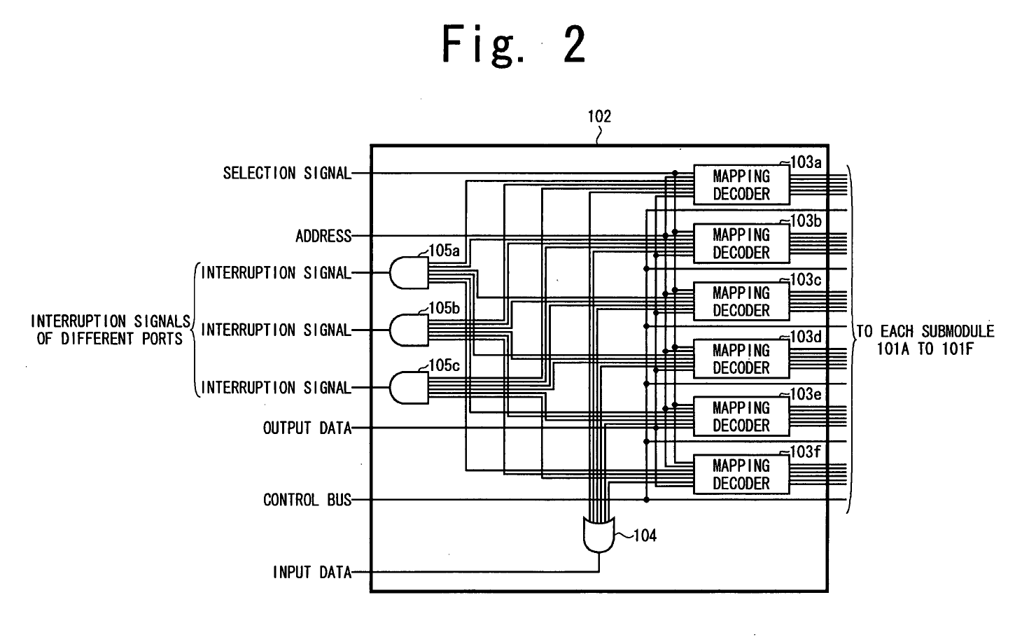

The address decoder 102 as being described is shown in FIG. 2. Referring to FIG. 2, the address decoder 102 has mapping decoders 103a to 103f, AND circuits 105a to 105c, and an OR circuit 104.

The mapping decoders 103a to 103f correspond to the submodules 101a to 101f on a one-to-one basis. For example, the mapping decoder 103a corresponds to the submodule 101a on a one-to-one basis. The mapping decoders 103a to 103f compare the port address (high bits of the address) stored in the corresponding submodule with the access address. If the port address and the access address matches, then those mapping decoders 103a to 103f send a selection signal to the corresponding submodule. In this way, one or more certain submodules among the submodules 101a to 101f are selected.

Furthermore, with respect to the output data received from the CPU 200, the mapping decoders 103a to 103f mask the bits other than the bits which are designated by the bit address (low bits of the address) stored in the submodules 101a to 101f. Then the mapping decoders 103a to 103f output the masked output data to the corresponding submodules 101a to 101f. With respect to the input data received from the submodules 101a to 101f, the mapping decoders 103a to 103f mask the bits other than the bits which are designated by the bit address (low bits of the address) stored in the submodules 101a to 101f. Then the submodules 101a to 101f output the masked input data to the CPU 200 via the OR circuit 104. In this description, the output data are the data to be outputted outside the LSI 1000 from inside the LSI 1000, and the input data are the data to be inputted inside the LSI 1000 from outside the LSI 1000.

The OR circuit 104 implements logical addition on the input data received from each mapping decoder in terms of each bit. Then the OR circuit 104 outputs the result of the logical addition to the CPU 200. The output of the OR circuit 104 and the CPU 200 is connected by a data bus. In this case, the bit width of the data bus is four bits. Each of the inputs of the OR circuit 104 and each of the mapping decoders 103a to 103f is connected by data bus whose bit width is four bits.

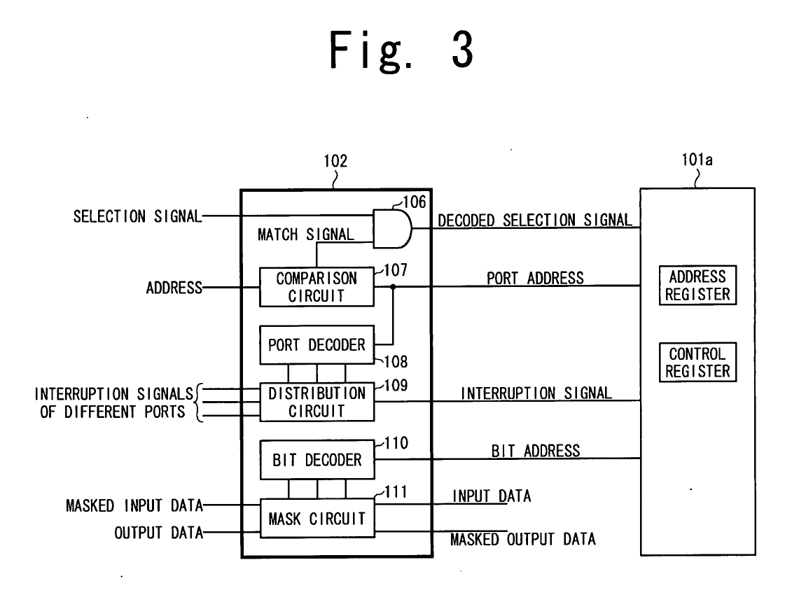

As shown in FIG. 3, the mapping decoder 103a includes an AND circuit 106, a comparison circuit 107, a port decoder 108, a distribution circuit 109, a bit decoder 110, and a mask circuit 111. The mapping decoders 103b to 103f include the same or similar structure as the mapping decoder 103a. Therefore, the mapping decoder 103a is mentioned as an example and explained in the following description, and redundant descriptions of the other mapping decoders 103b to 103f will be omitted.

Referring to FIGS. 1 to 3, the comparison circuit 107 compares the access address inputted from the CPU 200 with the port address stored in the submodule 101a. If the two of them match, the comparison circuit 107 outputs a match signal. When the match signal is outputted from the comparison circuit 107, the AND circuit 106 outputs the selection signal inputted from the CPU 200 to the corresponding submodule 101a. The port decoder 108 decodes the high bits (port address) of the address of the submodule 101a and outputs the result to the distribution circuit 109. When the interruption signal is inputted from the external connection terminal 300a via the submodule 101a, the distribution circuit 109 outputs “0” to the AND circuit 105a that corresponds to the output from the port decoder 108, i.e. the decoded port address. The bit decoder 110 decodes the bit address stored in the submodule 101a and outputs the result to the mask circuit 111.

The mask circuit 111 masks the output data and the input data on the basis of the output from the bit decoder 110, i.e. the decoded bit address. The output data are distributed to each of the mapping decoders 103a to 103f as shown in FIG. 2. Then the output data are masked by the mask circuit 111 of each of the mapping decoders 103a to 103f as shown in FIG. 3. After that, the masked output data are outputted to each of the corresponding submodules 101a to 101f. In this way, the masked output data are inputted to the submodules 101a to 101f. On the other hand, the input data from each of the submodules 101a to 101f are masked by the mask circuit 111, and after that, the masked input data are outputted to the OR circuit 104. In this way, masked input data are inputted to the OR circuit 104.

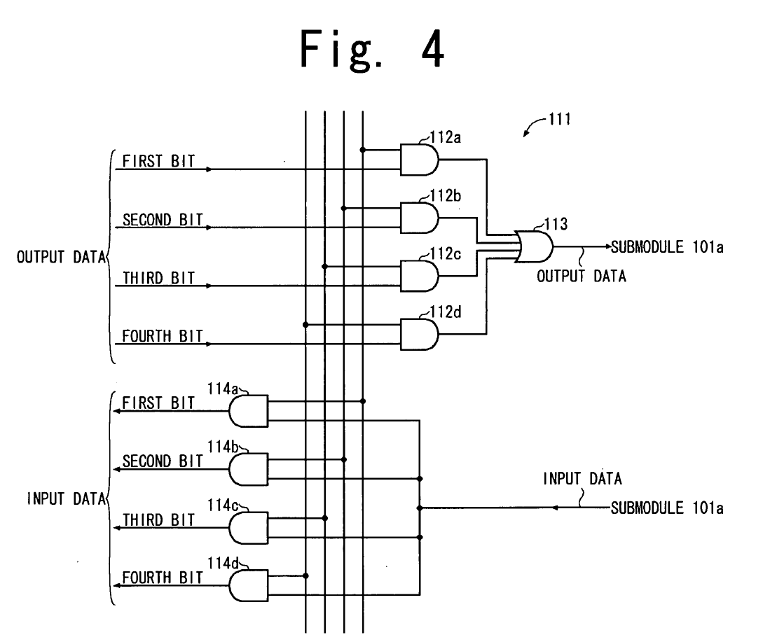

FIG. 4 shows an example of a structure of the mask circuit 111. The output data are inputted to AND circuits 112a to 112d as data of the bit width of the data bus (i.e. four bits). At the AND circuits 112a to 112d, the data other than the bits designated by the output of the bit decoder 110 are masked. For instance, in case of the submodule 101a, if the bit address stored in the submodule 101a represents the third bit, then “1” is inputted to the AND circuit 112c and the output data are outputted from the AND circuit 112c. At this time, on the other hand, “0” is inputted to the AND circuits 112a, 112b, and 112d, and the output data in these AND circuits 112a, 112b and 112d are masked. Then, the output data having passed through the AND circuit 112c are inputted to the submodule 101a via an OR circuit 113.

Likewise, with respect to the input data, the AND circuits 114a to 114d are provided with a number corresponding with the bit width of the data bus provided. The input data are outputted from the AND circuits 114a to 114d to the CPU 200 via the OR circuit 104. For instance, if the bit address stored in the submodule 101a represents the third bit, then “1” is inputted to the AND circuit 114c. At this time, on the other hand, “0” is inputted to the AND circuits 114a, 114b, and 114d and the input data in these AND circuits 112a, 112b and 112d are masked. Then, the masked input data are outputted to the OR circuit 104.

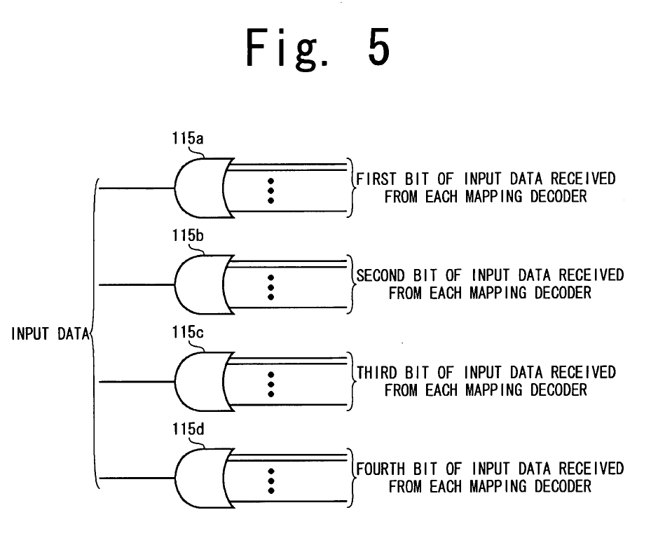

As shown in FIG. 5, the OR circuit 104 has OR circuits 115a to 115d, the number of the OR circuits corresponding with the bit width of the data bus on the input side. In the example of FIG. 5, the bit width of the data bus is four bits, and the OR circuit 104 includes four OR circuits 115a to 115d. The OR circuit 115a calculates the logical sum of the first bit of the input data outputted from each of the mapping decoders 103a to 103f, and outputs the result to the CPU 200. Likewise, the OR circuits 115b to 115c calculate the logical sum of the second to fourth bit of the input data respectively outputted from each of the mapping decoders 103a to 103f, and output the results to the CPU 200.

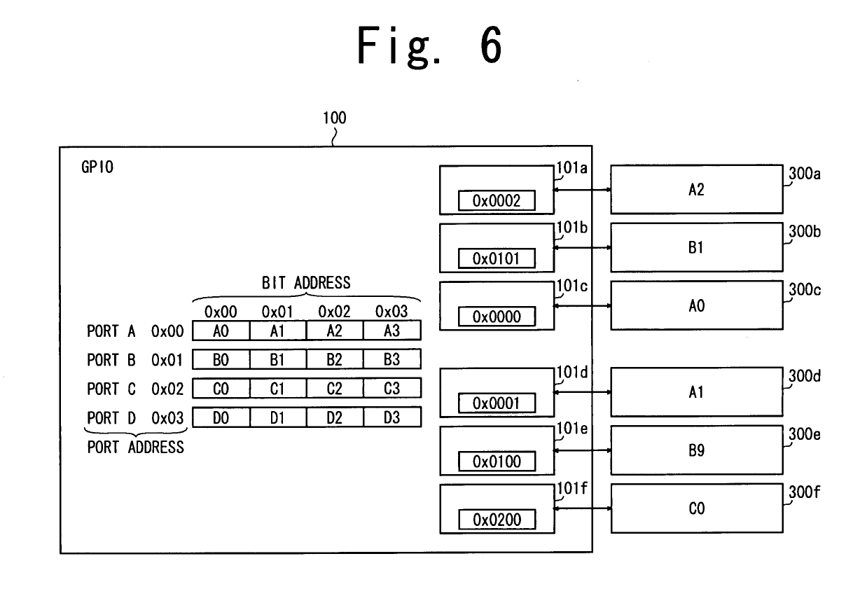

Next, a port structure between the submodules 101a to 101f and the external connection terminals 300a to 300f will be described using the example of a port structure shown in FIG. 6. This example explains the case where ports A to D are used. The port addresses of the ports A, B, C, and D are respectively 0x00, 0x01, 0x02, and 0x03. The bit addresses of the first, second, third, and fourth bits are 0x00, 0x01, 0x02 and 0x03, respectively The submodules 101a to 101f respectively correspond to the external connection terminals 300a to 300f in a one-to-one correspondence, and each of the submodules 101a to 101f is assigned with an address that is made of a port address and a bit address. The address assigned to each submodule is stored in the address register (FIG. 1). For example, the address assigned to the external connection terminal 300a is 0x0002. With respect to this address, the high bits 0x00 express the port address (port A), and the low bits 0x02 express the bit address which is the address of the bit belonging to the port A. Therefore, by rewriting the address memorized by the address register of each submodule, it is possible to change the port structure of the external connection terminals 300a to 300f. Although the number of ports and bits are four in this case, it is possible to change easily the number of ports and the number of bits by making the number of port addresses and the number of bit addresses fluctuate.

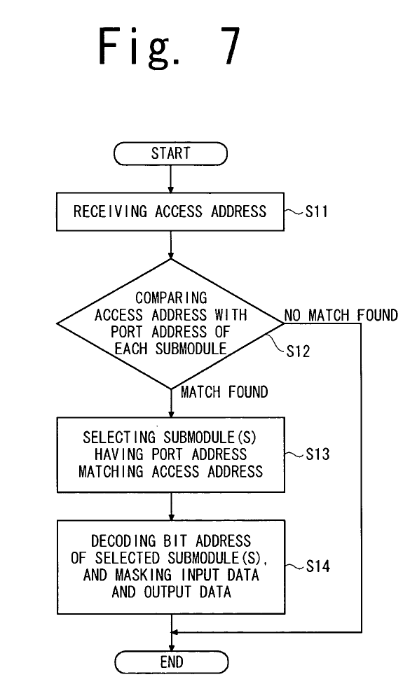

Next, access to the port A from the CPU 200 will be described with reference to FIG. 7. The GPIO 100 receives the port address 0x00 as an access address from the CPU 200, the port address 0x00 indicating the port A (step S11). Then the comparison circuit 107 (FIG. 3) of each of the mapping decoders 103a to 103f compares the access address 0x00 with the port address memorized by each of the submodules 101a to 101f (step S12). When there is a corresponding submodule where the two addresses match as a result of comparison (match found in step S12), the GPIO 100 outputs a selection signal to the corresponding submodule where the match of addresses is found (step S13). In this example, the selection signal is inputted to the submodules 101a, 101c, and 101d, and the submodules 101a, 101c, and 101d are selected. The selected submodules 101a, 101c, and 101d output the bit addresses respectively read from their address registers to the mapping decoders 103a, 103c, and 103d. At each of the mapping decoders 103a, 103c, and 103d, the bit address is decoded by the bit decoder 110, and the input data and the output data are masked by basing on this decoded bit address (step S14).

On the other hand, at step S12, if there is no corresponding submodule which stores the port address that matches the access address (no match found in step S12), the GPIO 100 ignores this access, and does not implement the processes of step S13 and step S14. For example, in the case where the GPIO 100 receives a port address 0x03 corresponding to the port D as the access address, since there is no corresponding submodule which stores the port address that is in agreement with the access address, the GPIO 100 disregards this access.

In concrete terms, for instance, if the bit address of the corresponding submodule 101a is 0x02, the third bit of the data bus will be selected in the mapping decoder 103a, and the other bits of the data bus will be masked. In the mapping decoder 103c, the first bit of the data bus will be selected and the other bits of the data bus will be masked. In the mapping decoder 103d, the second bit of the data bus will be selected and the other bits of the data bus will be masked. For example, when “1,” “0,” and “1” are inputted to the submodules 101a, 101c, and 101d, which constitute the port A, respectively, the third bit (i.e. 1) of the input data from the mapping decoder 103a, the first bit (i.e. 0) of the input data from the mapping decoder 103c and the second bit (i.e. 1) of the input data from the mapping decoder 103d are outputted to the OR circuit 104, and “0,” “1,” “1,” and “0” are respectively outputted from the OR circuits 115a to 115d corresponding to each bit.

In this way, according to the embodiment of the present invention, to what bit of which port each of the submodules 101a to 101f belongs can be controlled by the value of the address register. Therefore, port structure can be easily changed by the user side. In other words, by rewriting the address stored in each of the submodules 101a to 101f, the port address can be changed, and thereby the port structure of the submodules 101a to 101f can be easily changed. Moreover, by the change of the bit address, data transmission/reception can be accurately performed after the change of the port structure.

Furthermore, even in case of making usable the number of ports and bit width under the condition that a value of multiplication of the number of ports and the number of bit width is larger than the number of the external connection terminals (300a to 300f), it is no longer necessary to have as much the number of submodules as the number equivalent to the value of multiplication of the number of ports and the number of the bit width, but only enough number of submodules (101a to 101f) to correspond with the external connection terminals (300a to 300f). Specifically, what is necessary is to assign the submodules (101a to 101f) to take smaller bit width for each port in case of trying to have many ports, or to take smaller number of ports in case of trying to have larger number of bits.

In addition, by making the port address and bit address to be used fluctuate, the number of ports and the number of bits can be changed easily.

While the preferred embodiment of the invention have been described using specific terms, such description is for illustrative purposes only, and it is to be understood that changes and variations may be made without departing from the spirit or the scope of the following claims.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-144317. The entire disclosure of Japanese Patent Application No. 2004-144317 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A method of controlling an input/output unit with a plurality of terminal parts comprising:
arranging each of the terminal parts to store an address including a first address part and a second address part, and grouping the terminal parts according to said first address part;
receiving an access address for designating said first address part;
selecting a group of the terminal parts storing said first address part corresponding to said access address; and
controlling data transmission/reception via said group of selected terminal parts according to said second address part stored in each terminal part of said group of selected terminal parts.

2. The method of controlling an input/output unit according to claim 1, wherein
selecting said group of terminal parts includes,
comparing said access address with said first address part of each terminal part, and
outputting a selection signal to a terminal part of said group of selected terminal parts that stores said first address part that corresponds to said access address.

3. The method of controlling an input/output unit according to claim 1, wherein
controlling data transmission/reception via said group of selected terminal parts, with respect to said data transmitted/received via each of terminal part of said group of selected terminal parts, a part other than a part corresponding to said second address part stored in each terminal part of said group of selected terminal part is masked.

4. The method of controlling an input/output unit according to claim 1, wherein
said first address part is an address to specify a port that is usable in the input/output unit, and said second address part is a bit address to specify a bit that belongs to said port.

5. The method of controlling an input/output unit according to claim 4, wherein
the input/output unit is mounted on a semiconductor device having a plurality of external connection terminals, and said terminal parts of the input/output unit are respectively connected to said external connection terminals in one-to-one correspondence.

6. The method of controlling an input/output unit according to claim 5, wherein
a value of multiplication of a number of ports and a number of bit width is larger than a number of said external connection terminals.

7. The method of controlling an input/output unit according to claim 1, wherein
the input/output unit is a general purpose input/output module (GPIO).

8. An input/output unit comprising:
a plurality of terminal parts;
an address register being configured in each of said plurality of terminal parts, said address register storing an address including a first address part and a second address part;
a selection circuit being configured to receive an access address to designate said first address part, and to select a group of terminal parts storing said first address part corresponding to said access address; and
a transmission/reception control circuit being configured to control data transmission/reception via said terminal parts selected by said selection circuit, according to said second address part stored in each of said selected terminal parts.

9. The input/output unit according to claim 8, wherein
said selection circuit includes,
a comparison circuit that compares said access address with said first address part stored in each of said terminal parts, and
a selection signal output circuit that outputs a selection signal to said terminal part that stores said first address part that corresponds to said access address,
said comparison circuit and said selection signal output circuit are provided for each of said terminal parts.

10. The input/output unit according to claim 8, wherein
said transmission/reception control circuit masks a part other than said part corresponding to said second address part stored in each of selected terminal parts with respect to said data transmitted/received via each of selected terminal parts selected by said selection circuit.

11. The input/output unit according to claim 8, wherein
said first address part is an address to specify a port that is usable in said input/output unit, and said second address part is a bit address to specify a bit that belongs to said port.

12. The input/output unit according to claim 8,
said input/output unit being a general purpose input/output module (GPIO).

13. A semiconductor device comprising:
a plurality of external connection terminals; and
a mounted input/output unit having,
a plurality of terminal parts,
an address register being configured in each of said plurality of terminal parts, said address register storing an address including a first address part and a second address part,
a selection circuit being configured to receive an access address to designate said first address part, and to select a group of terminal parts storing said first address part corresponding to said access address, and
a transmission/reception control circuit being configured to control data transmission/reception via said terminal parts selected by said selection circuit, according to said second address part stored in each of said selected terminal parts.

14. The semiconductor device according to claim 13, wherein
said selection circuit includes,
a comparison circuit that compares said access address with said first address part stored in each of said terminal parts, and
a selection signal output circuit that outputs a selection signal to said terminal part that stores said first address part that corresponds to said access address,
said comparison circuit and said selection signal output circuit are provided for each of said terminal parts.

15. The semiconductor device according to claim 13, wherein
said transmission/reception control circuit masks a part other than said part corresponding to said second address part stored in each of selected terminal parts with respect to said data transmitted/received via each of selected terminal parts selected by said selection circuit.

16. The semiconductor device according to claim 15, wherein
said terminal parts of said input/output unit are respectively connected to said external connection terminals in one-to-one correspondence.

17. The input/output unit according to claim 16, wherein
said first address part is an address to specify a port that is usable in said input/output unit, and said second address part is a bit address to specify a bit that belongs to said port.

18. The semiconductor device according to claim 17, wherein
a value of multiplication of a number of ports and a number of bit width is larger than a number of said external connection terminals.

19. The semiconductor device according to claim 13, wherein
said input/output unit is a general purpose input/output module.

20. The semiconductor device according to claim 19, wherein
said general purpose input/output module is mounted on large scale integrated circuit.
